(19) United States
(12) Patent Application Publication
(10) Pub. No.: US 2018/0225368 A1
(43) Pub. Date: Aug. 9, 2018

(54) METHOD AND SYSTEM FOR VISUALLY PRESENTING ELECTRONIC RAW DATA SETS

(71) Applicant: Wolfgang GROND, Kulmbach (DE)

(72) Inventor: Wolfgang GROND, Kulmbach (DE)

(21) Appl. No.: 15/743,028

(22) PCT Filed: Jul. 14, 2016
(86) PCT No.: PCT/DE2016/100315

§ 371 Date: Jan. 9, 2018

(30) Foreign Application Priority Data
Jul. 16, 2015 (DE) 10 2015 111 549.2

(51) Int. Cl. G06F 17/30; G06K 9/62

(52) U.S. Cl. CPC G06F 17/30713; G06F 17/3069; G06F 17/30616; G06K 9/6268; G06K 9/6218

(57) ABSTRACT

A method for the computer-aided thematically grouped visual presentation of electronic, raw data sets, comprising the following steps: providing a plurality of electronic raw data sets, wherein each raw data set has at least one time specification or one unique identification characteristic as a property; generating a property vector for each of the raw data sets; creating a property matrix, the rows of which consist of the property vectors; performing calculations on the property matrix, namely a calculation of clusters of the data sets, a calculation of associations between selected data, a classification of the data sets, and/or a calculation of summarizations of data sets; reducing the dimension of the calculation results to the dimension two; determining the position of the dimension-reduced calculation results in a 2-D result space; generating a 3-D result space by adding the time specification or the unique identification characteristic as a third dimension to the 2-D result space mentioned above; and generating a visual three-dimensional presentation of the 3-D result space by using a graphical representation for the raw data sets to be visualized.

The invention relates to a process and a system for computer-aided thematically grouped visual representation of electronic output datasets.

There is generally a need to represent large amounts of data (text-based, but also non-text-based data volumes or documents) in a structured or thematically grouped manner in order to facilitate their usability. Such amounts of data originate, for example, in the scope of data mining analyses, especially text mining analyses, and may consist, for example, of scientific publications, patent documents, website contents, e-mails or documents which have been created or managed by means of a word processing program, a spreadsheet application, a presentation software or a database. Here, the output datasets are typically high-dimensional. Facilitating usability means in this context that the user is enabled to make documents/data of interest for him/her easily accessible by means of a graphic user interface.

In the state of the art, large amounts of data are made accessible, for example, via fulltext indexes incl. user interface, sorted lists or processes which permit extraction of key words or themes from the amount of output datasets without content-related precept, for ex. by means of topic models (see: A Survey of Topic Modeling in Text Mining, Rubayyi Alghamdi, Khalid Alfalqi, Concordia University Montreal, Quebec, Canada, (IJACSA) International Journal of Advanced Computer Science and Applications, Vol. 6, No. 1, 2015). Once a dataset of interest for the user has been found in this way, it is important to check the output volume as to which datasets of similar contents are additionally contained in it. To achieve this object, the output datasets are thematically grouped. Thematic grouping is effected, in this context, by processes of machine learning which can be assigned to the areas of “clustering” (=unsupervised learning; see: A Survey of Text Clustering Algorithms, Charu. C. Aggarwal, ChengXiang Zhai, (Ed.), Mining Text Data, Springer, 2012, DOI 10.1007/978-1-4614-3223-4_4) or “Classification” (=supervised learning; see: Machine Learning: A Review of Classification and Combining Techniques, S. B. Kotsiantis, I. D. Zaharakis, P. E. Pintelas, Springer 2007, DOI 10.1007/s10462-007-9052-3).

In all cases, it is desirable in this context to have an interactive user interface with the help of which documents of interest for the user can be selected directly. For a graphic representation of the result, it is necessary to be able to represent the high-dimensional output datasets graphically. An overview of existing processes for visualization of multi-dimensional data can be found in: Survey of multidimensional Visualization Techniques, Abdelaziz Maalej, Nancy Rodriguez, CGVCVIP'12: Computer Graphics, Visualization, Computer Vision and Image Processing Conference, July 2012, Lisbon, Portugal. To represent the results of clustering or classification processes, a method from the area of dimensionality reduction is normally used, with the dimension of the output datasets, as a rule, being reduced to two. A compilation of methods for dimensionality reduction can be found here: A Survey of Dimensionality Reduction Techniques, C.O.S. Sorzano, J. Vargas, A. Pascual-Montano, Natl. Centre for Biotechnology (CSIC), C/Darwin, 3. Campus Univ. Autónoma, 28049 Cantoblanco, Madrid, Spain, https://arxiv.org/pdf/1403.2877.

As there are large amounts of data, the probability that two or more output datasets are in the same location within a coordinate system after a dimensionality reduction is especially high if these are several datasets of the same or very similar contents (datasets of the same or very similar contents are by definition in the same location within the high-dimensional content space and consequently, after a dimensionality reduction, also in the same location within the two-dimensional space). This applies especially if processes such as e.g. Self Organizing Maps (SOM) are applied which use a pattern of fixed depicting points.

Due to the representation of two or more datasets in the same location within a coordinate system which are then superimposed in a way that is not discernible for the observer (like stars in the sky, whereby one star in the fore-ground hides the star located behind it), this representation in this form is not suitable as an interactive user interface to make the output datasets accessible. Users manage, for example, by superimposing the output datasets with a jitter (=artificial noise regarding amplitude and direction), which causes points which are really superimposed to be represented side-by-side (which, of course, falsifies the actual coordinates). Another option would be, for example, to open, by selection of a result representation, a window or menu which lists the output datasets which are in this location; However, in both the above-mentioned cases (i. e. jitter and window/menu), the user has to intervene in order to obtain a corresponding representation. With these processes, automated representation is not possible. In other words, this increases the required computing time and/or the arithmetic operations to be performed.

The object of the invention is to provide a process or a system which permits a clearly structured, thematically grouped visual representation of electronic datasets, in which the required computing time or the arithmetic operations to be performed are to be minimized. In other words, it is the object to provide a process or a system with the help of which high-dimensional output datasets can be represented by clearly distinguishable result representations even after a dimensionality reduction.

This object is solved by a process with the characteristics of claim 1 and a system with the characteristics of claim 12. Advantageous embodiments are described in the dependent claims.

The process according to the invention for computerized thematically grouped visual representation of electronic output datasets features the following process steps: (a) providing a plurality of electronic output data sets, each output data set comprising at least one time specification or one unique identification feature as an attribute; (b) generating an attribute vector for each of the output datasets; (c) creating an attribute matrix whose rows consist of the attribute vectors; (d) performing calculations on the attribute matrix, namely, a calculation of clusters of the datasets, a calculation of associations between selected data, a classification of the datasets and/or a calculation of aggregations of datasets; (e) reducing the dimension of the calculation results to the dimension two; (f) determining the position of the dimensionally reduced calculation results within a 2D sample space; (g) generating a 3D sample space by adding the time specification or the unique identification feature, respectively, as a third dimension to the above 2D sample space; and (h) generating a visual three-dimensional representation of the 3D sample space using a graphic representation for the output datasets to be visualized.

The result of the process is a three-dimensional (3D) representation in which the electronic output datasets are shown in a thematically grouped manner; especially output datasets which are thematically related to one another are displayed in physical proximity to one another. At the same time, by taking the time specification or the unique identification feature into account for the representation, the interrelation between the individual output datasets can be seen. Furthermore, the arithmetic operations required to this effect are of a relatively low computational complexity. To this extent, user intervention is not required for generating the representation. The process is instead executed automatically.

In other words, a focus of the present invention is on initially reducing the dimension of the output data to the dimension two. Subsequently, a third dimension is added which is based on the time specification or the unique identification feature. Thus, this third dimension is not a result of the dimensionality reduction, but independent of it. The 3D sample space thus created is then visualized. By utilization of the time specification or the unique identification feature, respectively, as third dimension in this representation, the clarity of the results shown is enhanced and user-friendliness improved.

The process can be used wherever complex system states are to be visualized so that access to high-dimensional output datasets is enabled with the help of a graphical user interface. In particular, system states of complex plants such as power plants, supply grids, production plants, traffic systems and/or medical apparatus can be displayed in a clearly structured fashion.

Hereby, the unique identification feature may especially be configured as a time stamp or a hash value.

Due to the fact that the third dimension of the result representation—even if a time specification is used—prior to representation thereof is not subject to a machine learning process, this is not a process of time-based data mining, such as is described for example in this publication: A survey of temporal data mining, SRIVATSAN LAXMAN and P S SASTRY, Department of Electrical Engineering, Indian Institute of Science, Bangalore 560 012, India, Sadhana Vol. 31, Part 2, April 2006, pp. 173-198.

In an advantageous embodiment, the electronic output datasets are configured as system states of a technical plant or technical apparatus, especially as system states of a power plant, a supply network, a production plant, a traffic system or medical apparatus.

In another advantageous embodiment, the electronic output datasets are configured as electronic documents each of which features a text consisting of words as semantic contents. In an especially advantageous manner, the electronic documents are configured as protection rights documents, especially patent or utility model documents, as scientific essays, as books in digital form or as journals in digital form. Hereby, the time specification is preferably configured as application or publication date. In this embodiment, the graphical representation comprises preferably an individualization flag, particularly a document number (patent number, DOI, ISBN, ISSN).

In another advantageous embodiment, the output datasets may also be configured, however, as numeric data, especially as aggregated numeric individual data which may have been collected, if applicable, from different data sources.

In another advantageous embodiment, the visual three-dimensional representation is rotatable and/or zoomable. Further, the visual three-dimensional representation can be generated by utilization of WebGL or OpenGL technology.

In an advantageous embodiment, the electronic documents are provided from one or more databases, particularly from one or more databases accessible via Internet.

Preferentially, the number of electronic output datasets amounts to 5 up to 500000 datasets, particularly 100 to 100000 datasets.

The system of the invention for computerized thematically grouped visual representation of electronic output datasets has a data processing system and an indicator connected to it. The system includes: (a) a provisioning unit for providing a plurality of electronic output data sets, each output data set comprising at least one time specification or a unique identification feature as an attribute; (b) a generating unit for generating an attribute vector for each of the output datasets; (c) a creation unit for creating an attribute matrix whose rows consist of the attribute vectors; (d) an implementation unit for performing calculations on the attribute matrix, namely, a calculation of clusters of the datasets, a calculation of associations between selected data, a classification of the datasets and/or a calculation of aggregations of data-sets; (e) a reduction unit for reducing the dimension of the calculation results to the dimension two; (f) a determination unit for determining the position of the dimensionally reduced calculation results within a 2D sample space; (g) a generating unit for generating a 3D sample space by adding the time specification or the unique identification feature, respectively, as a third dimension to the above 2D sample space; and (h) a generating unit for generating a visual three-dimensional representation of the 3D sample space in the indicator using a graphic representation for the output datasets to be visualized.

Hereby, the provisioning unit, the generating units, the creation unit, the reduction unit and the determination unit are preferably configured in form of a computer program (software) which is executed on the data processing system.

The invention described above can be used in an advantageous manner particularly for the following applications:

(1) In one application, it is possible to make the contents of minutes or all kinds of statements (maintenance records or meeting minutes, interviews, court orders, medical diagnoses, text blogs on the Internet, forums etc.) accessible in a thematically grouped manner.

(2) In another application, the system is used to make the contents of articles from newspapers, magazines or books in case of publishing houses or libraries, or manuals, operating instructions or legal texts accessible in a thematically grouped manner.

(3) In a third expression, such a system can be used to make the contents of patents, scientific publications, office documents, database contents or text contents from websites or e-mails etc. accessible in a thematically grouped manner in order to support e. g. product development or market research.

(4) In another application, the system can be used to visualize, in the case of banks or insurance companies, complex numeric datasets in a thematically grouped manner.

(5) It is also possible to use such a system in order to implement a new interface for customer data in commerce.

(6) In another application, system states of complex plants such as power plants, supply grids, production plants, traffic systems, medical apparatus etc. can be displayed in a clearly structured fashion.

(7) This type of analysis is suitable in general wherever complex system states are to be visualized so that access to high-dimensional output datasets is enabled with the help of a graphical user interface.

The invention has been explained in further detail by way of an exemplary embodiment in the drawing figures, whereby:

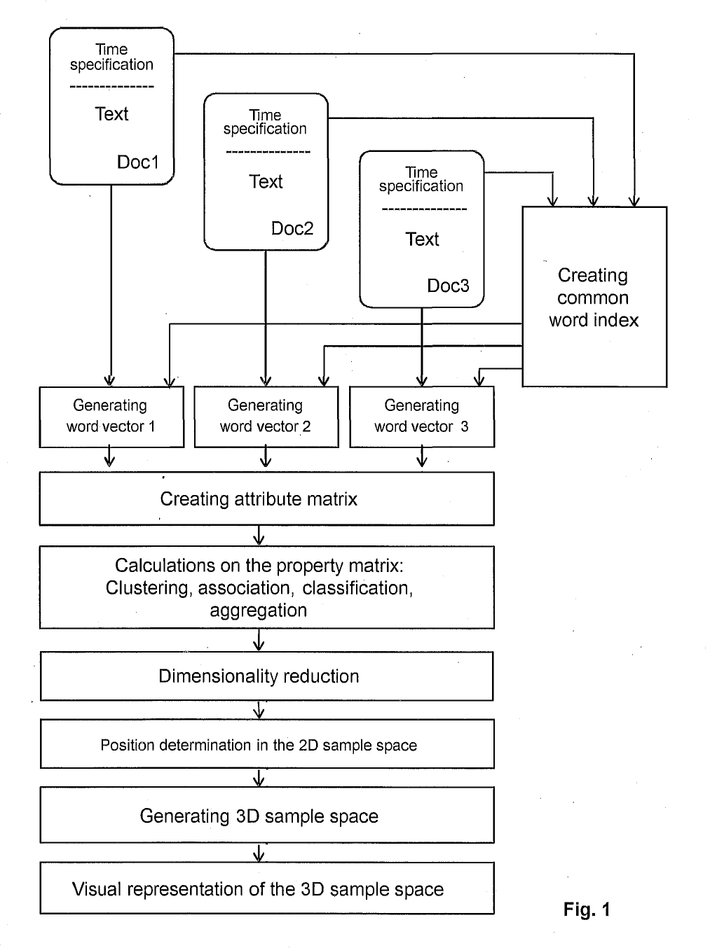

FIG. 1 shows a flowchart of the process of computerized thematically grouped visual representation of electronic output datasets;

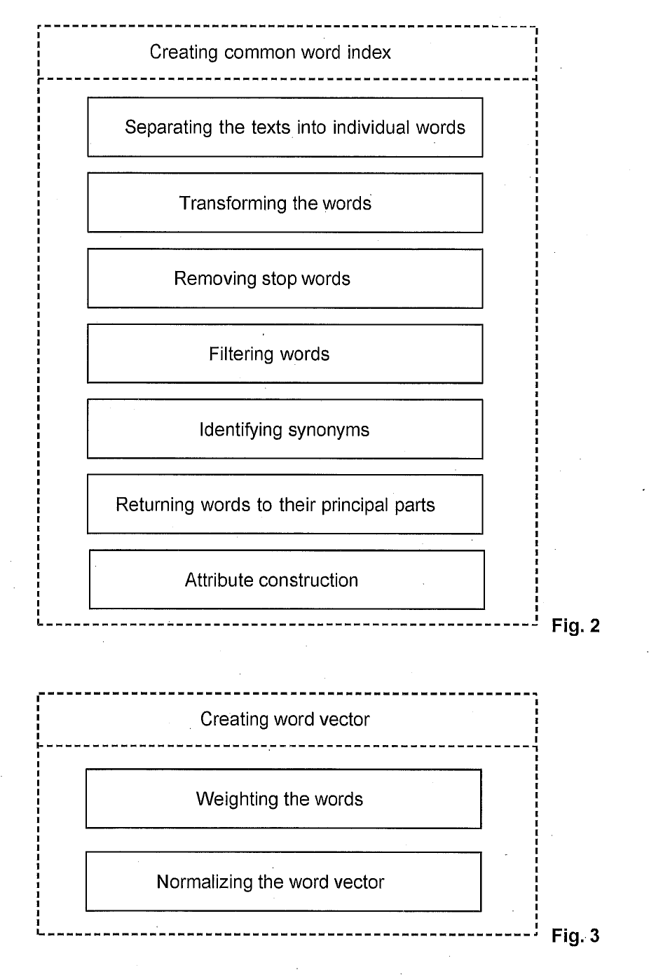

FIG. 2 shows a flowchart of the process step “Creating common word index” from FIG. 1;

FIG. 3 shows a flowchart of the process step “Generating word vector” from FIG. 1; and

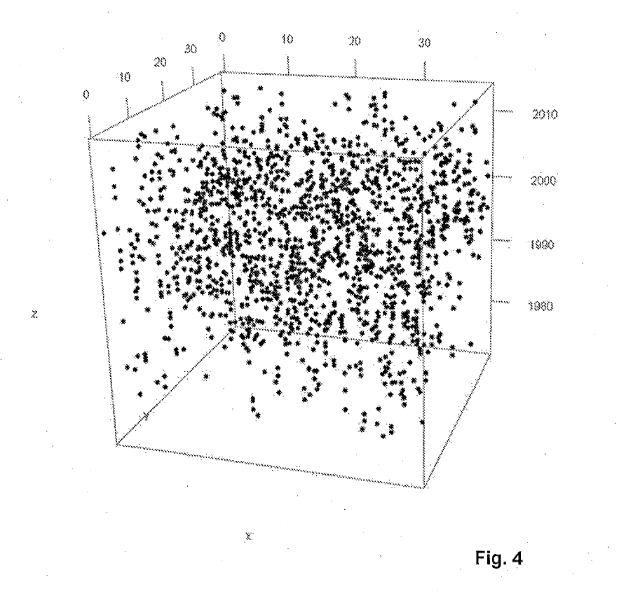

FIG. 4 shows an exemplary visual representation of a 3D sample space.

FIGS. 1 to 3 each show schematic flowcharts in the form of block diagrams which illustrate the sequence of the process steps of the process.

The process shown in FIG. 1 for computerized thematically grouped visual representation of electronic output datasets commences with the process step “Providing a plurality of electronic output datasets, with each output dataset having at least one time specification as an attribute”. In the exemplary embodiment shown, here the electronic output datasets are configured as electronic documents, each having a text consisting of words in terms of semantic contents and a time specification as attribute. In FIG. 1, these electronic documents have been identified for example as Doc1 to Doc3.

More precisely, the text of the electronic document in question may be a patent document (or part of a patent document, e.g. patent claims), and the time specification may be the date of application or the date of disclosure of the patent document.

Subsequently, the process step “Generating an attribute vector for each of the output datasets” follows. This process step has been implemented in the process shown in FIG. 1 by the steps “Creating common word index” and “Generating word vector 1” or “Generating word vector 2” and “Generating word vector 3”.

In the step “Creating common word index”, a common word index is created from collected words of the electronic documents. The additional steps which might be performed to this effect are shown schematically in FIG. 2, whereby not all the steps shown need be performed. Performing selected steps only is also possible.

In the scope of the step of separating the texts into individual words, random, especially the following processes can be used:
process in which the words are generated by separating the text at all the characters which are not letters;
process in which the words are generated by separating the text in all the characters which are specified by definition as separator;
process in which the words are generated by separating the text in all the characters which are identified as separators by an algorithm entered.

In the step for the transformation of words, a process for converting all strings to lower-case letters or for converting all strings to upper-case letters can be used, for example.

In the step of removing stop words, a process according to the method “Looking up in a list”, according to the method “Term Frequency”, according to the method “Term-Based Random Sampling”, “according to the method “Term Entropy Measures”, according to the method “Maximum Likelihood Estimation”, a so-called supervised or a so-called unsupervised process can be used, for example.

In the step of filtering words (or text parts), a so-called pruning process can be used particularly, preferably one of the following processes:
process in which words below and above a certain length are not taken into consideration;
process according to Bottom-Up-Pruning, particularly process according to the method “Reduced Error Pruning”, according to the method “Minimum Cost-Complexity-Pruning” and/or according to the method “Minimum Error Pruning”;
process according to Top-Down-Pruning, particularly process according to the method “Pessimistic Error Pruning”.

In the step for identification of synonyms in the word index, particularly processes for identification of synonyms by looking up in a dictionary or Thesaurus and/or a process for identification of synonyms according to the method “Unsupervised Near-Synonym Generation” can be used. However, other processes for identification of synonyms in the word index can also be used.

In the step of returning words of the word index to their appropriate principal part, so-called stemming processes can be used particularly, preferably one of the following processes:
processes which implement stemming by looking up in a Table;
processes which implement stemming by lemmatization;
processes which implement stemming by truncation, particularly processes in which truncation is effected according to the method “Lovin”, according to the method “Porter”, according to the method “Paice/Husk” or according to the method “Dawson”;
processes which implement stemming by statistical methods, particularly processes in which the method “N-Gram”, the method “HMM” or the method “YASS” are used;
processes which implement stemming by so-called mixed methods, particularly processes following inflexion-based and derivation-based methods according to “Krovetz” or according to “Xerox”, according to so-called corpus-based methods or according to so-called context-sensitive methods.

However, other processes for returning words of the word index to their appropriate principal parts can also be used.

In the step for construction of attributes, a construction of derived document attributes can be made of existing basic attributes. Hereby, one of the following processes is preferably used:
processes which implement construction of derived document attributes by the method “Decision tree” (FRINGE, CITRE, FICUS, and variants derived therefrom);
processes which implement the construction of derived document attributes by application of operators (particularly +, −, *, /, Min., Max., average (mean, median), standard deviation, equivalence, (in)equality);
processes which implement the construction of derived document attributes by the method “Inductive Logic Programming (ILP)”;
processes which implement the construction of derived document attributes based on annotations or comments (Annotation Based Feature Construction);
processes in which the construction of derived document attributes is implemented by the method “Evolutionary Aggregation”;
processes in which the construction of derived document attributes is implemented by the method “Generating Genetic Algorithm—GGA”;
processes in which the construction of derived document attributes is implemented by the method “Generating Genetic Algorithm—AGA”;
processes in which the construction of derived document attributes is implemented by the method “Generating Genetic Algorithm—YAGGA”;
processes in which the construction of derived document attributes is implemented by the method “Generating Genetic Algorithm—YAGGA2”.

However, other processes for the construction of derived document attributes from existing basic attributes can also be used.

In the step “Generating word vector”, a so-called word vector is created for each of the electronic documents (in FIG. 1 for example for the three documents Doc1 to Doc3) whose dimension corresponds to the dimension of the word index and whose components specify the abundance of each word of the word index within the document.

The additional steps which might be performed to this effect are shown schematically in FIG. 3, whereby not all the steps shown need be performed. Performing selected steps only is also possible.

In the step of weighting the words of the word vector, any processes may be used for weighting. Particularly, one of the following processes may be used:
process according to the method “Local Weighting”, preferably according to the method “Binary Term Occurrence”, according to the method “Term Occurrence”, according to the method “Term Frequency”, according to the method “Logarithmic Weighting” or according to the method “Augmented Normalized Term Frequency (Augnorm)”;
process according to the method “Global Weighting”, preferably according to the method “Binary Weighting”, according to the method “Normal Weighting”, according to the method “Inverse Document Frequency”, according to the method “Squared Inverse Document Frequency”, according to the method “Probabilistic Inverse Document Frequency”, according, to the method “GFIDF”, according to the method “Entropy”, according to the method “Genetic Programming”, according to the method “Revision History Analysis” or according to the method “Alternate Logarithm”;
process according to the method “Forward Optimization”;
process according to the method “Backward Optimization”;
process according to the method “Evolutionary Optimization”;
process according to the method “Particle Swarm Optimization”.

In the step for normalization of the word vector, particularly one process according to the method “Cosine Normalization”, according to the method “Sum of Weights”, according to the method “Fourth Normalization”, according to the method “Maximum Weight Normalization” or according to the method “Pivoted Unique Normalization” can be used. However, other processes for normalization of the word vector can also be used.

Overall, the “word vectors” in FIG. 1 represent attribute vectors within the meaning of the present invention.

Once the word vectors are available, an attribute matrix is formed. More precisely, the word vectors are joined to form an attribute matrix by writing the word vectors underneath one another row by row.

Subsequently, calculations (mathematical transformations) are performed on the attribute matrix, i. e. a calculation of clusters of the datasets, a calculation of associations between selected data, a classification of the datasets and/or a calculation of aggregations of datasets.

Hereby, the calculation of clusters of the datasets may comprise clustering according to one or more of the following processes: clustering according to the method “Artificial Neural Network” (see: Survey of Clustering Data Mining Techniques, Pavel Berkhin, 2002), clustering according to the method “Artificial Neural Network—particularly SOM” (see: http://de.wikipedia.org/wiki/Teuvo_Kohonen, retrieved in June 2015), clustering according to the method “Constraint-Based Clustering” (see: Survey of Clustering Data Mining Techniques, Pavel Berkhin, 2002), clustering according to the method “Density Based Partitioning” (see: Survey of Clustering Data Mining Techniques, Pavel Berkhin, 2002; Categorization of Several Clustering Algorithms from Different Perspective: A Review, N. Soni et al., International Journal of Advanced Research in Computer Science and Software Engineering 2 (8), August 2012, pp. 63-68), clustering according to the method “Evolutionary Algorithms” (see: A Survey of Evolutionary Algorithms for Clustering, E. R. Hruschka et al., IEEE Transactions on Systems, Man, and Cybernetics, Part C: Applications and Reviews, 39(2), 133-155, 2009), clustering according to the method “Fuzzy Clustering” (see: A Comparison Study between Various Fuzzy Clustering Algorithms, K. M. Bataineh, Jordan Journal of Mechanical and Industrial Engineering, (4), 335-343, 2011), clustering according to the method “Graph-Based Clustering” (see: http://en.wikipedia.org/wiki/Cluster_analysis, retrieved in June 2015), clustering according to the method “Grid-Based Clustering” (see: Survey of Clustering Data Mining Techniques, Pavel Berkhin, 2002; Categorization of Several Clustering Algorithms from Different Perspective: A Review, N. Soni et al., International Journal of Advanced Research in Computer Science and Software Engineering 2 (8), August 2012, pp. 63-68), clustering according to the method “Group Models” (see: http://en.wikipedia.org/wiki/Cluster_analysis, retrieved in June 2015), clustering according to the method “Gradient Descent” (see: Survey of Clustering Data Mining Techniques, Pavel Berkhin, 2002), clustering according to the method “Hierarchical Clustering” (see: Survey of Clustering Data Mining Techniques, Pavel Berkhin, 2002; Categorization of Several Clustering Algorithms from Different Perspective: A Review, N. Soni et al., International Journal of Advanced Research in Computer Science and Software Engineering 2 (8), August—2012, pp. 63-68), clustering according to the method “Lingo” (see: http://en.wikipedia.org/wiki/Carrot2, retrieved in June 2015), clustering according to the method “Partitioning Relocation Clustering” (see: Survey of Clustering Data Mining Techniques, Pavel Berkhin, 2002; Categorization of Several Clustering Algorithms from Different Perspective: A Review, N. Soni et al., International Journal of Advanced Research in Computer Science and Software Engineering 2 (8), August 2012, pp. 63-68), clustering according to the method “Subspace-Clustering” (see: Survey of Clustering Data Mining Techniques, Pavel Berkhin, 2002; Categorization of Several Clustering Algorithms from Different Perspective: A Review, N. Soni et al., International Journal of Advanced Research in Computer Science and Software Engineering 2 (8), August 2012, pp. 63-68), clustering according to the method “Suffix Tree Clustering (STC)” (see: http://en.wikipedia.org/wiki/Suffix_tree, retrieved in June 2015). However, other processes for clustering of the datasets can also be used.

Classification of the datasets may comprise classification according one or more of the following processes: Classification according to the method “Decision tree” (see: Supervised Machine Learning: A Review of Classification Techniques, S. B. Kotsiantis, Informatica 31, 2007, 249-268), classification according to the method “Perceptron” (see: Supervised Machine Learning: A Review of Classification Techniques, S. B. Kotsiantis, Informatica 31, 2007, 249-268), classification according to the method “Radial Basis Function (RBF)” (see: Supervised Machine Learning: A Review of Classification Techniques, S. B. Kotsiantis, Informatica 31, 2007, 249-268), classification according to the method “Bayesian Network (BN)” (see: Supervised Machine Learning: A Review of Classification Techniques, S. B. Kotsiantis, Informatica 31, 2007, 249-268), classification according to the method “Instance Based Learning” (see: Supervised Machine Learning: A Review of Classification Techniques, S. B. Kotsiantis, Informatica 31, 2007, 249-268), classification according to the method “Support Vector Machines (SVM)” (see: A Review of Classification Techniques, S. B. Kotsiantis, Informatica 31, 2007, 249-268). However, other processes for classification of the datasets can also be used.

The calculation of associations between selected data may comprise a calculation according to one or more of the following processes: calculation according to the method “Apriori” (see: http://en.wikipedia.org/wiki/Association_rule_learning, retrieved in June 2015), calculation according to the method “Eclat” (see: http://en.wikipedia.org/wiki/Association_rule_learning, retrieved in June 2015), calculation according to the method “FP-growth” (see: http://en.wikipedia.org/wiki/Association_rule_learning, retrieved in June 2015), calculation according to the method “AprioriDP” (see: http://en.wikipedia.org/wiki/Association_rule_learning, retrieved in June 2015), calculation according to the method “Context Based Association Rule Mining Algorithm—CBPNARM” (see: http://en.wikipedia.org/wiki/Association_rule_learning, retrieved in June 2015), calculation according to the method “Node-set-based algorithms” (see: http://en.wikipedia.org/wiki/Association_rule_learning, retrieved in June 2015), calculation according to the method “GUHA” (see: http://en.wikipedia.org/wiki/Association_rule_learning, retrieved in June 2015), calculation according to the method “OPUS search” (see: http://en.wikipedia.org/wiki/Association_rule_learning, retrieved in June 2015). However, other processes for calculation of associations can also be used.

The calculation of aggregations of datasets may comprise a calculation according to one or more of the following processes: calculation according to the method “TF-IDF Based Summary”, calculation according to the method “Centroid-Based Summary”, calculation according to the method “(Enhanced) Gibbs Sampling”, calculation according to the method “Lexical Chains”, calculation according to the method “Graph-Based Summary”, calculation according to the method “Maximum Marginal Relevance Multi Document (MMR-MD) Summarization”, calculation according to the method “Cluster-Based Summary”, calculation according to the method “Position-Based Summary”, calculation according to the method “Latent Semantic Indexing (LSI)”, calculation according to the method “Latent Semantic Analysis (LSA)”, calculation according to the method “KMeans”, calculation according to the method “Probabilistic Latent Semantic Analysis (pLSA)”, calculation according to the method “Latent Dirichlet Allocation (LDA)”, calculation according to the method “LexRank”, calculation according to the method “TextRank”, calculation according to the method “Mead”, calculation according to the method “MostRecent”, calculation according to the method “SumBasic”, calculation according to the method “Latent Dirichlet Allocation (LDA)”, calculation according to the method “Artificial Neural Network (ANN)”, calculation according to the method “Decision Tree”, calculation according to the method “Deep Natural Language Analysis”, calculation according to the method “Hidden Markov Model”, calculation according to the method “Log-Linear Model”, calculation according to the method “Naive-Bayes”, calculation according to the method “RichFeatures”. However, other processes for aggregation of datasets can also be used.

For details regarding the above-mentioned processes, refer to the following sources:
Artificial Neural Network (ANN): A Survey on Automatic Text Summarization, D. Das, A. F. P. Martins, Language Technologies Institute, Carnegie Mellon University, 2007
Centroid-Based Summary: A Comparative Study of Text Data Mining Algorithms and its Applications, A. G. Jivani, Thesis, Department of Computer Science and Engineering, The Maharaja Sayajirao University of Baroda, Vadodara, India, 2011
Cluster-Based Summary: A Comparative Study of Text Data Mining Algorithms and its Applications, A. G. Jivani, Thesis, Department of Computer Science and Engineering, The Maharaja Sayajirao University of Baroda, Vadodara, India, 2011
Decision Tree: A Survey on Automatic Text Summarization, D. Das, A. F. P. Martins, Language Technologies Institute, Carnegie Mellon University, 2007
Deep Natural Language Analysis: A Survey on Automatic Text Summarization, D. Das, A. F. P. Martins, Language Technologies Institute, Carnegie Mellon University, 2007
(Enhanced) Gibbs Sampling: A Comparative Study of Text Data Mining Algorithms and its Applications, A. G. Jivani, Thesis, Department of Computer Science and Engineering, The Maharaja Sayajirao University of Baroda, Vadodara, India, 2011
Graph-Based Summary: A Comparative Study of Text Data Mining Algorithms and its Applications, A. G. Jivani, Thesis, Department of Computer Science and Engineering, The Maharaja Sayajirao University of Baroda, Vadodara, India, 2011
Hidden Markov Model: A Survey on Automatic Text Summarization, D. Das, A. F. P. Martins, Language Technologies Institute, Carnegie Mellon University, 2007
KMeans: A Comparative Study of Text Data Mining Algorithms and its Applications, A. G. Jivani, Thesis, Department of Computer Science and Engineering, The Maharaja Sayajirao University of Baroda, Vadodara, India, 2011
Latent Dirichlet Allocation (LDA): A Comparative Study of Text Data Mining Algorithms and its Applications, A. G. Jivani, Thesis, Department of Computer Science and Engineering, The Maharaja Sayajirao University of Baroda, Vadodara, India, 2011
Latent Semantic Analysis (LSA): A Comparative Study of Text Data Mining Algorithms and its Applications, A. G. Jivani, Thesis, Department of Computer Science and Engineering, The Maharaja Sayajirao University of Baroda, Vadodara, India, 2011
Latent Semantic Indexing (LSI): A Comparative Study of Text Data Mining Algorithms and its Applications, A. G. Jivani, Thesis, Department of Computer Science and Engineering, The Maharaja Sayajirao University of Baroda, Vadodara, India, 2011
Lexical Chains: A Comparative Study of Text Data Mining Algorithms and its Applications, A. G. Jivani, Thesis, Department of Computer Science and Engineering, The Maharaja Sayajirao University of Baroda, Vadodara, India, 2011
LexRank: Comparing Twitter Summarization Algorithms for Multiple Post Summaries, D. Inouye et al., IEEE Third International Conference on Social Computing (SocialCom), 298-306, Boston, Mass., USA, 2011
Log-Linear Model: A Survey on Automatic Text Summarization, D. Das, A. F. P. Martins, Language Technologies Institute, Carnegie Mellon University, 2007
Maximum Marginal Relevance Multi Document (MMR-MD) Summarization: A Comparative Study of Text Data Mining Algorithms and its Applications, A. G. Jivani, Thesis, Department of Computer Science and Engineering, The Maharaja Sayajirao University of Baroda, Vadodara, India, 2011
Mead: Comparing Twitter Summarization Algorithms for Multiple Post Summaries, D. Inouye et al., IEEE Third International Conference on Social Computing (SocialCom), 298-306, Boston, Mass., USA, 2011
MostRecent: Comparing Twitter Summarization Algorithms for Multiple Post Summaries, D. Inouye et al., IEEE Third International Conference on Social Computing (SocialCom), 298-306, Boston, Mass., USA, 2011
Naive-Bayes: A Survey on Automatic Text Summarization, D. Das, A. F. P. Martins, Language Technologies Institute, Carnegie Mellon University, 2007
Position-Based Summary: A Comparative Study of Text Data Mining Algorithms and its Applications, A. G. Jivani, Thesis, Department of Computer Science and Engineering, The Maharaja Sayajirao University of Baroda, Vadodara, India, 2011
Probabilistic Latent Semantic Analysis (pLSA): A Comparative Study of Text Data Mining Algorithms and its Applications, A. G. Jivani, Thesis, Department of Computer Science and Engineering, The Maharaja Sayajirao University of Baroda, Vadodara, India, 2011
RichFeatures: A Survey on Automatic Text Summarization, D. Das, A. F. P. Martins, Language Technologies Institute, Carnegie Mellon University, 2007
SumBasic: Comparing Twitter Summarization Algorithms for Multiple Post Summaries, D. Inouye et al., IEEE Third International Conference on Social Computing (SocialCom), 298-306, Boston, Mass., USA, 2011
TextRank: Comparing Twitter Summarization Algorithms for Multiple Post Summaries, D. Inouye et al., IEEE Third International Conference on Social Computing (SocialCom), 298-306, Boston, Mass., USA, 2011
TF-IDF Based Summary: A Comparative Study of Text Data Mining Algorithms and its Applications, A. G. Jivani, Thesis, Department of Computer Science and Engineering, The Maharaja Sayajirao University of Baroda, Vadodara, India, 2011

Afterwards (i. e. after the calculations on the attribute matrix), the dimension of the calculation results (e.g. the word vectors) is reduced to the dimension two. To this effect, preferably one of the following processes is used:
process in which the dimensionality reduction is implemented via linear methods, preferably according to the method “Principle Component Analysis (dimensionality reduction by main component analysis)”, according to the method “Linear Discriminant Analysis (dimensionality reduction by discriminant analysis)”, according to the method “Canonical Correlation Analysis (dimensionality reduction by correlation analysis” or according to the method “Singular Value Decomposition (dimensionality reduction by singular value decomposition)”;
process in which the dimensionality reduction is implemented by non-linear methods, preferably according to the method “Autoenkoder”, according to the method “Curvelinear [sic!] Component Analysis”, according to the method “Curvelinear [sic!] Distance Analysis”, according to the method “Data-Driven High-Dimensional Scaling”, according to the method “Diffeomorphic Dimensionality Reduction”, according to the method “Diffusion Maps”, according to the method “Elastic Map”, according to the method “Gaussian Process Latent Variable Model”, according to the method “Growing Self-organizing Map”, according to the method “Hessian Locally-Linear Embedding”, according to the method “Independent Component Analysis”, according to the method “Isomap”, according to the method “Kernel Principal Component Analysis”, according to the method “Laplacian Eigenmaps”, according to the method “Locally-Linear Embedding”, according to the method “Local Multidimensional Scaling”, according to the method “Local Tangent Space Alignment”, according to the method “Manifold Alignment”, according to the method “Manifold Sculpting”, according to the method “Maximum Variance Unfolding”, according to the method “Multidimensional Scaling”, according to the method “Modified Locally-Linear Embedding”, according to the method “Neural Network”, according to the method “Nonlinear Auto-Associative Neural Network”, according to the method “Nonlinear Principal Component Analysis”, according to the method “Principal Curves and manifolds”, according to the method “RankVisu”, according to the method “Relational Perspective Map”, according to the method “Restricted Boltzmann Machine”, according to the method “Sammon's Mapping”, according to the method “Self-organizing Map”, according to the method “Supervised Dictionary Learning”, according to the method “t-distributed Stochastic Neighbor Embedding”, according to the method “Topologically Constrained Isometric Embedding” or according to the method “Unsupervised Dictionary Learning”.

However, other processes for dimensionality reduction can also be used.

Subsequently, the position of the dimensionally reduced calculation results in a 2D sample space is determined. In other words, the position of the dimensionally reduced calculation results is determined.

Subsequently, a 3D sample space is created by adding the time specification or the unique identification feature to the above 2D sample space as a third dimension.

The 3D sample space thus created is represented visually in a three-dimensional way, graphic representatives being used for the output datasets to be visualized. The following can be considered especially as graphic representatives: symbols, meta data of the output datasets, patent numbers, Digital Object Identifiers (DOIs), International Standard Book Numbers (ISBN), International Standard Series Numbers (ISSN), titles, tags or other content-related integral parts of the document, names of applicant, inventor, author, editor or publishing house, visualizations of single- or multi-dimensional statistic document attributes, pictorial representations of the documents as such, document-related audio or video file, links to the documents as such.

The result of the process is a three-dimensional (3D) representation in which the electronic documents are shown in a thematically grouped manner; especially records which are thematically related to one another are displayed in physical proximity to one another. At the same time, consideration of the time specification in the representation shows the temporal link between the various documents. Furthermore, the arithmetic operations required to this effect are of a relatively low computational complexity.

FIG. 4 shows an exemplary visual representation of a 3D sample space created via the process described above. In other words, FIG. 4 is an exemplary representation of a graphic result representation of the process of the invention. The two coordinate axes with a range of values from zero to 40 form the (two-dimensional) level of results created by dimensionality reduction of the high-dimensional output datasets. By adding a third dimension which does not originate from dimensionality reduction (in the present case, this is a time coordinate; indicated: years), the 3D sample space is created in which the graphic result representations of the output datasets can be separated safely without spatial overlaps occurring. Thus, such a representation is suitable as a graphic user interface for making the output datasets accessible in an interactive manner. The representation is rotatable and zoomable; data objects can be clicked.

The method described above is implemented on a system with a data processing system and an indicator connected to it. A computer program which executes the process steps described above is executed on the data processing system.

In the exemplary embodiment shown in the Figures, the electronic output datasets have been configured as electronic documents. Further, a word index is formed and the attribute vector is configured as word vector. However, it is also possible to configure the electronic output datasets as aggregated numeric individual data, particularly as aggregated numeric individual data from different data sources. Analogously, a data index would be formed and the attribute vector would be based on the individual data of the data index. Particularly the following additional steps can be performed in creating the attribute vector:

application of statistical basic processes, processing faulty values, processing missing values, processing outliers, processing infinite values, processing meta data, data scaling. Further, the output datasets may be system states of a technical plant or technical apparatus, especially system states of a power plant, a supply network, a production plant, a traffic system or medical apparatus.

The exemplary embodiment shown in the Figures uses a time specification to generate the 3D sample space. However, it is also possible to use another unique identification feature, e.g. a hash value, to this effect.

1. Process for computerized thematically grouped visual representation of electronic output datasets with the following process steps:
Providing a plurality of electronic output datasets, whereby each output dataset has at least one time specification or one unique identification feature as an attribute;
Generating an attribute vector for each of the output datasets;
Creating an attribute matrix the rows of which consist of the attribute vectors;
Performing calculations on the attribute matrix, i. e. a calculation of clusters of the datasets, a calculation, of associations between selected data, a classification of the datasets and/or a calculation of aggregations of datasets;
Reducing the dimension of the calculation results to the dimension two;
Determining the position of the dimensionally reduced calculation results in a 2D sample space;
Generating a 3D sample space by adding the time specification or the unique identification feature to the above 2D sample space as a third dimension; and
Generating a visual three-dimensional representation of the 3D sample space using a graphic representation for the output datasets to be visualized.

2. Process according to claim 1, the unique identification feature being a time stamp or a hash value.

3. Process according to claim 1, whereby the electronic output datasets provided are electronic documents each of which has a semantic content which is a text consisting of words; and whereby in the process step “Generating an attribute vector”, initially a common word index is generated from aggregated words of the electronic documents and subsequently the attribute vector is generated whose dimension corresponds to the dimension of the word index and whose components specify the abundance of each word of the word index within the document.

4. Process according to claim 3, whereby in the process step “Generating an attribute vector”, one or more of the following steps are performed additionally:
Separating the texts into individual words, removing stop words from the word index, filtering words and text parts, identifying synonyms in the word index, returning words of the word index to their appropriate principal part, transforming words of the word index, attribute construction, weighting of the words of the attribute vector, normalizing the attribute vector.

5. Process according to claim 1, whereby the electronic output datasets provided are aggregated numeric individual data from different data sources; and whereby in the process step “Generating an attribute vector”, initially a common data index is generated and subsequently the attribute vector is generated whose dimension corresponds to the dimension of the data index and whose components specify the expression of the individual datum of the data index within the aggregation concerned.

6. Process according to claim 5, whereby in the process step “Generating an attribute vector”, one or more of the following steps are performed additionally: Application of statistical basic processes, processing faulty values, processing missing values, processing outliers, processing infinite values, processing meta data, data scaling.

7. Process according to claim 1, whereby the calculation of clusters of the datasets comprises clustering according to one or more of the following methods: clustering according to the method “Artificial Neural Network”, clustering according to the method “Artificial Neural Network—especially SOM”, clustering according to the method “Constraint-Based Clustering”, clustering according to the method “Density Based Partitioning”, clustering according to the method “Evolutionary Algorithms”, clustering according to the method “Fuzzy Clustering”, clustering according to the method “Graph-Based Clustering”, clustering according to the method “Grid-Based Clustering”, clustering according to the method “Group Models”, clustering according to the method “Gradient Descent”, clustering according to the method “Hierarchical Clustering”, clustering according to the method “Lingo”, clustering according to the method “Partitioning Relocation Clustering”, clustering according to the method “Subspace-Clustering”, clustering according to the method “Suffix Tree Clustering (STC)”.

8. Process according to claim 1, whereby the calculation of associations between selected data comprises a calculation according to one or more of the following methods: calculation according to the method “Apriori”, calculation according to the method “Eclat”, calculation according to the method “FP-growth”, calculation according to the method “AprioriDP”, calculation according to the method “Context Based Association Rule Mining Algorithm—CBPNARM”, calculation according to the method “Nodeset-based algorithms”, calculation according to the method “GUHA”, calculation according to the method “OPUS search”.

9. Process according to claim 1, whereby the classification of the datasets comprises classification according to one or more of the following methods: classification according to the method “Decisiontree”, classification according to the method “Perceptron”, classification according to the method “Radial Basis Function (RBF)”, classification according to the method “Bayesian Network (BN)”, classification according to the method “Instance Based Learning”, classification according to the method “Support Vector Machines (SVM)”.

10. Process according to claim 1, whereby the calculation of aggregations of datasets comprises a calculation according to one or more of the following methods: calculation according to the method “TF-IDF Based Summary”, calculation according to the method “Centroid-Based Summary”, calculation according to the method “(Enhanced) Gibbs Sampling”, calculation according to the method “Lexical Chains”, calculation according to the method “Graph-Based Summary”, calculation according to the method “Maximum Marginal Relevance Multi Document (MMR-MD) Summarization”, calculation according to the method “Cluster-Based Summary”, calculation according to the method “Position-Based Summary”, calculation according to the Method “Latent Semantic Indexing (LSI)”, calculation according to the method “Latent Semantic Analysis (LSA)”, calculation according to the method “KMeans”, calculation according to the method “Probabilistic Latent Semantic Analysis (pLSA)”, calculation according to the method “Latent Dirichlet Allocation (LDA)”, calculation according to the method “LexRank”, calculation according to the method “TextRank”, calculation according to the Method “Mead”, calculation according to the method “MostRecent”, calculation according to the method “SumBasic”, calculation according to the method “Artificial Neural Network (ANN)”, calculation according to the method “Decision Tree”, calculation according to the method “Deep Natural Language Analysis”, calculation according to the method “Hidden Markov Model”, calculation according to the method “Log-Linear Model”, calculation according to the method “Naive-Bayes”, calculation according to the method “RichFeatures”.

11. Process according to claim 1, whereby the graphic representation is configured as: symbol, meta data of the output dataset, patent number, Digital Object Identifiers (DOI), International Standard Book Number (ISBN), International Standard Series Number (ISSN), title, tag or other content-related integral part of the document, names of applicant, inventor, author, editor or publishing house, visualization of single- or multidimensional statistic document attributes, pictorial representation of the output datasets as such, output dataset-related audio or video file, link to the output dataset as such.

12. System for computerized thematically grouped visual representation of electronic output datasets with a data processing system and an indicator connected to it, the system comprising
a provisioning unit for providing a plurality of electronic output datasets, whereby each output dataset has at least one time specification or one unique identification feature as an attribute;
a generating unit for generating an attribute vector for each of the output datasets;
a creation unit for creating an attribute matrix the rows of which consist of the attribute vectors;
an implementation unit for performing calculations on the attribute matrix, i. e. a calculation of clusters of the datasets, a calculation of associations between selected data, a classification of the datasets and/or a calculation of aggregations of datasets;
a reduction unit for reducing the dimension of the calculation results to the dimension two;
a determination unit for determining the position of the dimensionally reduced calculation results in a 2D sample space;
a generating unit for generating a 5 3D sample space by adding the time specification or the unique identification feature as a third dimension to the above 2D sample space; and
a generating unit for generating a visual three-dimensional representation of the 3D sample space on the indicator using a graphic representation for the output datasets to be visualized.
